(19) United States
(12) Patent Application Publication
(10) Pub. No.: US 2011/0027435 A1
(43) Pub. Date: Feb. 3, 2011

(54) CUPCAKE MOLD AND METHOD FOR MAKING CUPCAKE POPS

(76) Inventors: Jeanette Facey, Osterville, MA (US); Mark Facey, Osterville, MA (US)

Correspondence Address: Leason Ellis LLP, 81 Main Street, Suite 503, White Plains, NY, 10601, US

(21) Appl. No.: 12/533,954

(22) Filed: Jul. 31, 2009

(51) Int. Cl. A23G 3/54; A21C 14/00; A23G 3/50; A23G 3/56

(52) U.S. Cl. 426/306; 249/162; 426/389; 426/302

(57) ABSTRACT

A cupcake mold includes two mold forms connected by a hinge and separable by a flange on an end opposite the hinge. Each mold form has a series of flutes extending in one direction and a top having a defined shape, such as a series of rings or a snail-shell shape, extending generally perpendicularly to the flutes. A method for making a dough-based edible treat includes the steps of filling an interior of a mold with a volume of dough, closing the mold to shape the dough, reopening the mold to expose the shaped dough, and removing the shaped dough from the mold. A further method adds the steps of extending a portion of a stick into the shaped dough to provide a handle for the edible treat, and, optionally, dipping at least a portion of the shaped dough into a liquid while the holding the stick.

### BACKGROUND OF THE INVENTION

1. Field of the Invention

This invention relates to a device and method for preparing a dough-based edible treat, such as a cupcake. More specifically, the device and method are performed with the use of a shaped mold of certain configuration and can be used to prepare a treat without the need for cooling or heating the dough.

2. Description of the Prior Art

Baked goods containers used for shaping portions of cupcakes and similar dough-based, edible treats are known in the art. For example, in U.S. Des. Pat. No. D257,116, Lakatos et al. teach one such container. Lakatos et al.'s container is useful for baking dough in an oven which permits the dough to rise freely from the pan, expand, and define a generally mushroom-shaped top.

Placing food on a stick is also well known as a method of preparing certain foods, for example for roasting a marshmallow or skewering meat or cheese. In addition, some foods can be formed on a stick such as popsicles and lollipops.

It would be an improvement in the art to have a mold configured to completely define the shape of a dough-based treat without the necessity of heating or cooling it, which, in one aspect, allows for children to be safely involved without supervision. It would be a further benefit to have a mold of certain design that enables ready shaping of the treat from unshaped dough. Of further benefit is a method that utilizes such a mold and a stick to mount the treat for further food-preparation steps such as dipping into melted chocolate or another liquid.

### SUMMARY OF THE INVENTION

This invention concerns, in a broad aspect, a method for forming a shaped, edible dough treat that can be supported from a stick, and, in further aspects, to a mold that is configured to form the dough treat into a cupcake shape.

In one implementation, the mold is shaped like a cupcake, both exteriorly and interiorly. The mold is comprised of two mold forms. The first and second mold forms each comprise a bottom portion having flutes extending generally normally to the mold. The top portion can have a series of rings extending generally perpendicularly to the direction of the flutes, and a cap portion disposed on one of the rings. The mold further comprises a flange extending generally normally from the cap portion of each of the first and second mold forms. A hinge connects the bottom portion of the two mold forms for hinged movement of one mold form relative to the other mold form between a first open position in which the interior the two mold forms is exposed and a second closed position in which the interior is concealed.

The interior of the cupcake mold is shaped so as to impart shape the dough, which in this implementation, is the shape of a cupcake. When the cupcake mold is in the second closed position, the interior defines a continuous, circumferential pattern of fluting along the bottom portion. Also, rings along the top portion of the mold up to and including the cap impart a corresponding pattern to the dough when the cupcake mold is in the second, closed position.

In another implementation, the cupcake mold has a snail-shell shape along the top portion instead of rings and a cap. In this implementation, the dough has the snail-shape imparted to it when the first and second mold forms are in the closed position.

In a further aspect, the invention concerns a method for preparing a dough-based, edible treat in which a mold is filled with a volume of dough. The mold has two mold parts that are moveable so as to expose a shaped interior mold-form that can receive the volume of dough. After filling the interior of the mold with dough, the user moves the first and second mold parts together, so as to conceal the volume of dough and concomitantly shape the volume of dough in accordance with the shaped interior mold-form. This allows the dough-based, edible treat to assume the shape of the interior of the mold. The two mold parts are then moved (e.g., separated) so as to expose the shaped volume of dough. The shaped volume of dough is removed from the mold. A portion of a stick is extended into the shaped volume of dough so as to provide a handle for the edible treat.

In a still further aspect of the foregoing method, the shaped dough is dipped into a liquid such as chocolate after it is removed from the mold and while being mounted on a stick.

These and further aspects, features and advantages can be appreciated from the accompanying drawing Figures and the detailed description of certain embodiments of the invention.

### BRIEF DESCRIPTION OF THE DRAWINGS

FIG. 1 is a top view of the cupcake mold in accordance with one embodiment of the present invention.

FIG. 2 is a plan view of the cupcake mold of FIG. 1.

FIG. 3 is a plan view of the cupcake mold of FIG. 1, shown rotated ninety degrees relative to FIG. 2.

FIG. 4 is a bottom view of the cupcake mold of FIG. 1.

FIG. 5 is an exploded view showing two mold-forms that comprise the cupcake mold of FIG. 1.

FIG. 6 is a perspective view of the the cupcake mold of FIG. 1 illustrating an interior thereof.

FIG. 7 is a perspective view of the cupcake mold of FIG. 1 illustrating an exterior thereof.

### DETAILED DESCRIPTION OF CERTAIN EMBODIMENTS OF THE INVENTION

By way of overview and introduction, the accompanying figures illustrate one embodiment of a mold in which the mold is configured to transform a blob of dough into a cupcake shape. The various figures illustrate details of a mold constructed in accordance with a preferred embodiment.

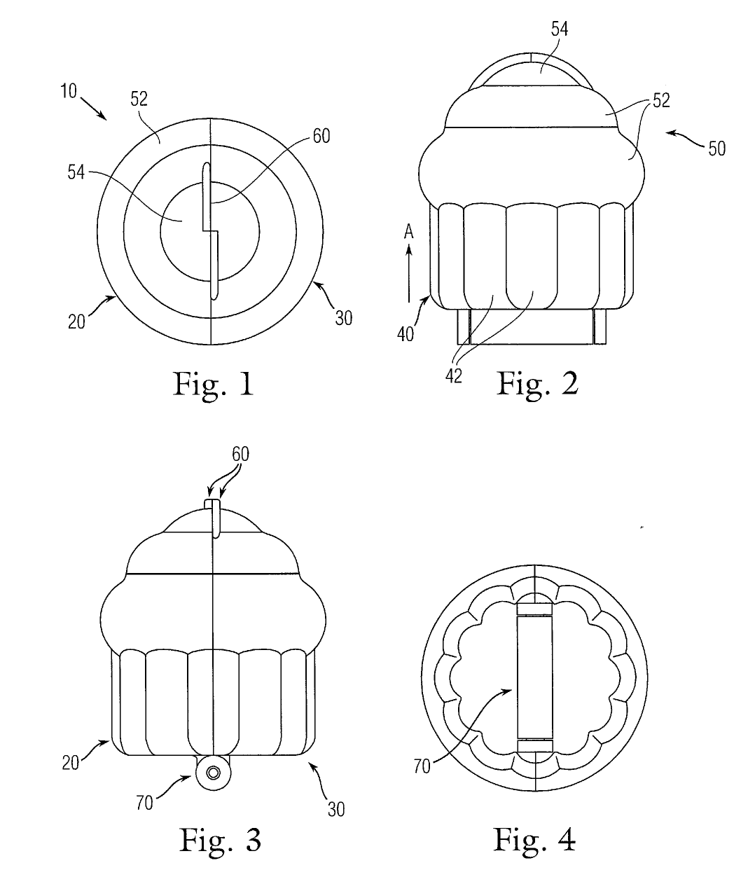

Turning now to FIGS. 1 through 4, one embodiment of the mold 10 generally comprises two mold forms 20 and 30 that each define a bottom portion 40 and a top portion 50. The mold forms are separable at one end with the help of flanges 60 and connected together at an opposite end by a hinge 70.

Referring now to FIGS. 1 and 2, further details of the mold form 20 are described. In the illustrated embodiment, mold form 30 is a mirror image of mold form 20. The bottom portion 40 of the mold form 20 includes flutes 42 extending in a direction A. The flutes can be adjacent one another or spaced by intervening material, and their contour can be varied in a number of known patterns. Atop the flutes, extending generally perpendicularly, is the top portion 50. In the illustrated embodiment, the top portion has a series of rings 52 topped by a cap 54. In other words, the cap portion is disposed on one of the rings. A flange 60 is located on the cap of each of the two mold forms 20 and 30, such as at a location that is adjacent to an edge of the mold forms. The flange extends generally normally from the cap portion.

In another embodiment of the invention, instead of a series of rings 52 and cap 54, a snail-shell shape or spiral can be provided as the top portion 50. In this case, the flange is positioned upon the snail-shell shape, such as at the edge of the mold forms as described above.

The plan view of FIG. 3 and the bottom view of FIG. 4 show the mold ninety degrees clockwise rotated relative to the view in FIG. 2. As illustrated, the two mold forms 20 and 30 can join together to provide a continuous exterior in this embodiment. The flanges 60 can be pressed upon to hinge the first mold away from the second mold form, about hinge 70, as can be appreciated from the discussion below.

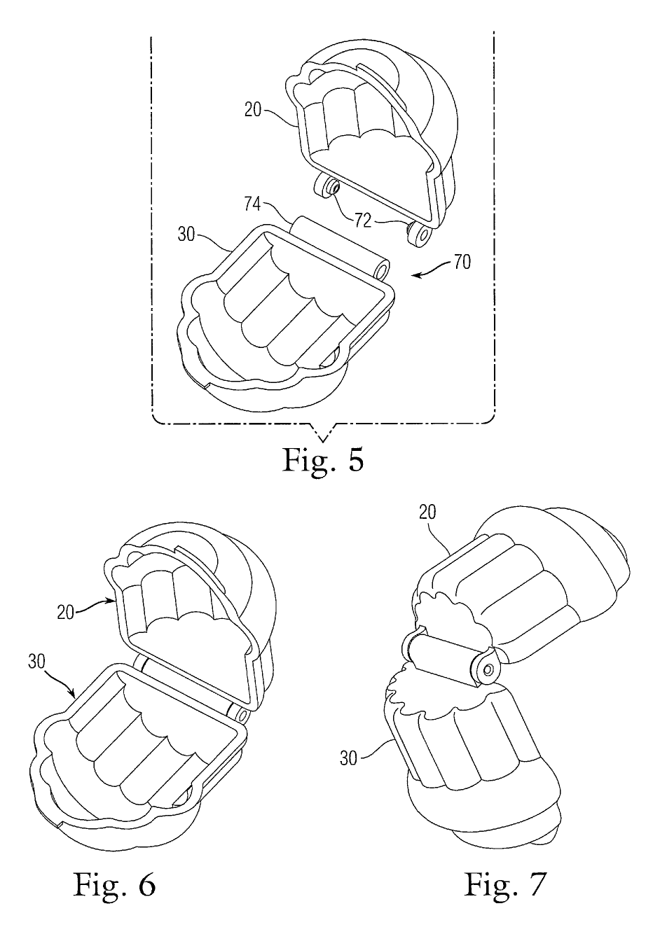

FIG. 5 illustrates the components that comprise the hinge 70 of the illustrated embodiment. Mold form 20 is provided with two circular extensions having knobs 72 at one end. Meanwhile, mold form 30 has a receptacle shaped and sized to receive the knobs 72 in a snap-lock relationship. In other words, the receptacle and knobs can be press-fit together with mild yielding of the knobs as the knobs are pressed against the edge of the receptacle until they are fully received in the receptacle. The knobs flex and return to their unstressed state once the knobs are seated in the receptacle. Thereafter, the two mold forms are joined. The result of such a joining is the hinge 70 that can move the mold from a (first) open position to a (second) closed position. As can be appreciated, in lieu of the knobs 72, the hinge 70 can comprise the circular extensions and the receptacle arranged with a through lumen sized to receive a pin about which the mold forms 20, 30 can pivot relative to each other.

The interior of the mold is exposed in the open position, but not in the closed position. FIGS. 5 and 6 illustrate the interior region of the mold 10. In the illustrated embodiment, the interior and exterior of the mold are complementarily formed, but that is not required. The exterior can have a shape that differs from the interior region in an alternative implementation.

The interior of the mold 10 defines a continuous, circumferential pattern of fluting along the bottom portion and rings along the top portion, when the first and second mold-forms are in the closed position. In another embodiment, the closed position shapes dough within the mold so as to have a snail-shell shape.

The cupcake mold in the present invention can be used with conventional bread or cake dough that requires heating in a conventional oven or refrigeration in order to impart and hold a mold-shape. Alternatively, the mold can be used with dough that can be shaped at room temperature, such as a mixture of ingredients that does not require heating or cooling. One such mixture that can be used to form an edible treat is a mixture of OREO®-brand Cookies and cream cheese or sweet cheese. In a method in accordance with the invention, a dough that can be shaped quickly at room temperature comprises a mixture of OREO®-brand Cookies and cream cheese. This mixture permits treat preparation free of any ovens or hot surfaces and can be handled by young children in a safe manner.

The invention also includes a method for preparing a shaped, edible dough treat, such as a cupcake, cookie, etc. This is accomplished by filling a mold with a volume of dough. The mold has two mold parts that are moveable so as to expose a shaped interior mold form that receives the volume of dough. After filling the interior of the mold with dough, the user moves the first and second mold parts to conceal the volume of dough and concomitantly shape the volume of dough in accordance with the shaped interior mold form. This allows the shaped, edible dough treat to have roughly the same shape as the interior of the mold. The two mold parts are then moved to expose the shaped volume of dough. The shaped volume of dough is now removed from the mold. Next, a portion of a stick can be extended into the shaped volume of dough to provide a handle for the edible treat, if desired. This allows children and adults to enjoy the treat without getting the treat, their hands, or their surroundings dirty. In one embodiment of the invention, at least a portion of the shaped dough could be dipped into chocolate or some other sauce after it is removed from the mold. The stick provides a handle for the treat while the dipping occurs. This allows complete immersion of the treat into a liquid while holding the stick rather than the treat itself.

This description is illustrative of the principles of this invention. As numerous modifications and changes will readily occur to those skilled in the art, it is not desired to limit the invention to the exact construction and process shown and described above. Rather, the invention is only limited by the following claims.

We claim:

1. A cupcake mold, comprising:
first and second mold forms each defining a bottom portion having flutes extending in a first direction, a top portion having a series of rings extending generally perpendicular to the first direction, and a cap portion disposed on one of the rings;
a flange extending generally normally from the cap portion of each of the first and second mold forms; and
a hinge connecting the bottom portion of the first and second mold forms for hinged movement of the first mold form relative to the second mold form between a first position in which an interior of the first and second mold forms is exposed and a second position in which the interior is concealed,
wherein the interior defines a continuous, circumferential pattern of fluting along the bottom portion and rings along the top portion when the first and second mold forms are in the second position.

2. The cupcake mold in claim 1, wherein the first and second mold forms have the same shape.

3. A cupcake mold, comprising:
first and second mold forms each defining a bottom portion having flutes extending in a first direction, a top portion having a snail-shell shape extending generally perpendicular to the first direction;
a flange extending generally normally from one end of each of the first and second mold forms; and
a hinge connecting the bottom portion of the first and second mold forms for hinged movement of the first mold form relative to the second mold form between a first position in which an interior of the first and second mold forms is exposed and a second position in which the interior is concealed,
wherein the interior defines a continuous, circumferential pattern of fluting along the bottom portion and the snail-shell shape along the top portion when the first and second mold forms are in the second position.

4. A method for preparing a dough-based, edible treat, comprising the steps of:
filling a mold with a volume of dough, the mold having first and second mold parts that are moveable so as to expose a shaped interior mold form that receives the volume of dough;
moving the first and second mold parts to conceal the volume of dough and concomitantly shape the volume of dough in accordance with the shaped interior mold form;
thereafter moving the first and second mold parts to expose the shaped volume of dough; and
removing the shaped volume of dough from the mold.

5. The method of claim 4, further comprising the step of extending a portion of a stick into the shaped volume of dough so as to provide a handle for the edible treat.

6. The method of claim 4, further comprising the step of dipping at least a portion of the shaped dough into a liquid while the holding the stick.

7. The method of claim 5, further comprising the step of melting chocolate and using the melted chocolate as the liquid.
